(19) United States
(12) Patent Application Publication
(10) Pub. No.: US 2024/0362552 A1
(43) Pub. Date: Oct. 31, 2024

(54) ESTIMATION DEVICE, ESTIMATION METHOD, AND ESTIMATION PROGRAM

(71) Applicant: NIPPON TELEGRAPH AND TELEPHONE CORPORATION, Tokyo (JP)

(72) Inventors: Toshitaka MAKI, Musashino-shi, Tokyo (JP); Nagisa SEKIGUCHI, Musashino-shi, Tokyo (JP); Masakuni ISHII, Musashino-shi, Tokyo (JP)

(73) Assignee: NIPPON TELEGRAPH AND TELEPHONE CORPORATION, Tokyo (JP)

(21) Appl. No.: 18/292,955

(22) PCT Filed: Aug. 19, 2021
(86) PCT No.: PCT/JP2021/030335

§ 371 Date: Jan. 29, 2024

(51) Int. Cl. G06Q 10/0631; G06Q 10/0639

(52) U.S. Cl. CPC G06Q 10/063112; G06Q 10/06398

(57) ABSTRACT

An estimation device configured to estimate career plan candidates for a subject user includes an acquisition unit, an estimation unit, and an estimation result output unit. The acquisition unit acquires business features for each business that the subject user has been in charge of up to the present. Thereafter, the estimation unit estimates career plan candidates appropriate for the subject user from the subject user's business features on the basis of a model trained using business features of each reference user who has responded that he/she has an aptitude for his/her current business field. The estimation result output unit outputs results of estimating the career plan candidates appropriate for the subject user.

### TECHNICAL FIELD

The present invention relates to an estimation device, an estimation method, and an estimation program for estimating career plan candidates of a user.

### BACKGROUND ART

When a career plan of a user (for example, an employee) is considered, it is necessary to make a determination in consideration of both the characteristics of the user and the characteristics of his/her organization (such as, for example, a department).

### CITATION LIST

### Non Patent Literature

[NPL 1] Basic Knowledge of Human Resource Development, 7th Career Design, [accessed on Jul. 9, 2021], the Internet <https://hr.nttls.co.jp/column/knowledge/step1/detail-07.html>

### SUMMARY OF INVENTION

### Technical Problem

However, in addition to a wide variety of user characteristics, there are also many organizations. Therefore, it takes time and effort to examine combinations of all user characteristics and organization characteristics in order to consider career plan candidates for a user. In addition, even if a career plan candidate is considered using the above method, it is not necessarily appropriate for the user. Consequently, an object of the present invention is to solve the above problems, reduce the time and effort required when career plan candidates for a user are considered, and improve the degree of accuracy.

### Solution to Problem

In order to solve the above problems, according to the present invention, there is provided an estimation device configured to estimate career plan candidates for a subject user, the device including: an acquisition unit configured to acquire business features for each business that the subject user has been in charge of up to the present; an estimation unit configured to estimate career plan candidates appropriate for the subject user from the subject user's business features on the basis of a model trained using business features of each reference user who has responded that he/she has an aptitude for his/her current business field; and an estimation result output unit configured to output results of estimating the estimated career plan candidates appropriate for the subject user.

### Advantageous Effects of Invention

According to the present invention, it is possible to reduce the time and effort required when career plan candidates for a user are considered, and to improve the degree of accuracy.

### BRIEF DESCRIPTION OF DRAWINGS

FIG. 1 is a diagram illustrating an overview of the operation of an estimation device.

FIG. 2 is a diagram illustrating an example of career plan candidates for an employee output by the estimation device of FIG. 1.

FIG. 3 is a diagram illustrating an example of career plan candidates for a manager output by the estimation device of FIG. 1.

FIG. 4 is a diagram illustrating an example of personnel data used by the estimation device.

FIG. 5 is a diagram illustrating learning data used by the estimation device and an overview of a flow from model learning to estimation of career plan candidates.

FIG. 6 is a diagram illustrating a configuration example of the estimation device.

FIG. 7 is a diagram illustrating a specific example of data preprocessing and generation of feature amounts performed by the estimation device.

FIG. 8 is a diagram illustrating an example of characteristics used by the estimation device to generate feature amounts.

FIG. 9 is a diagram illustrating an example of feature amounts generated by the estimation device.

FIG. 10 is a diagram illustrating the degree of importance of each feature amount with respect to the career axis.

FIG. 11 is a diagram illustrating the degree of importance of each feature amount with respect to future business types.

FIG. 12 is a diagram illustrating the degree of importance of each feature amount with respect to short-term business types.

FIG. 13 is a diagram illustrating target setting performed by the estimation device.

FIG. 14 is a flowchart illustrating an example of a procedure for the estimation device to train a model.

FIG. 15 is a flowchart illustrating an example of a procedure for the estimation device to estimate career plan candidates for a subject user.

FIG. 16 is a diagram illustrating results of verifying the estimation performance of career plan candidates for a subject user performed by the estimation device.

FIG. 17 is a diagram illustrating a configuration example of a computer that executes an estimation program.

### DESCRIPTION OF EMBODIMENTS

Hereinafter, modes (embodiments) for carrying out the present invention will be described with reference to the accompanying drawings. The present invention is not limited to embodiments to be described below.

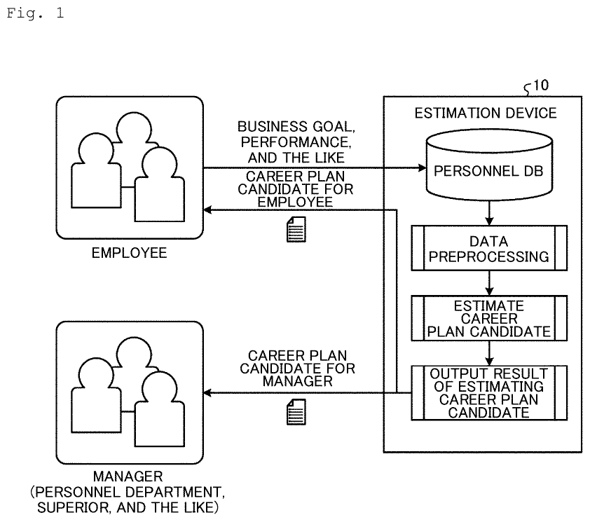

First, an overview of the operation of an estimation device of the present embodiment will be described with reference to FIG. 1. Here, a case in which an estimation device 10 estimates career plan candidates for an employee on the basis of the employee's business goals, performance, and the like will be described.

First, the estimation device 10 acquires the employee's business goals, performance, and the like, and registers them in a personnel database (DB). Thereafter, the estimation device 10 executes preprocessing of data in the personnel DB. The estimation device 10 uses the preprocessed personnel DB data to train a model (a model that outputs results of estimating career plan candidates for an employee on the basis of the business feature of the employee), and estimates career plan candidates for the employee on the basis of the model after learning. The estimation device 10 then outputs the results of estimating career plan candidates to the employee or the manager of the employee.

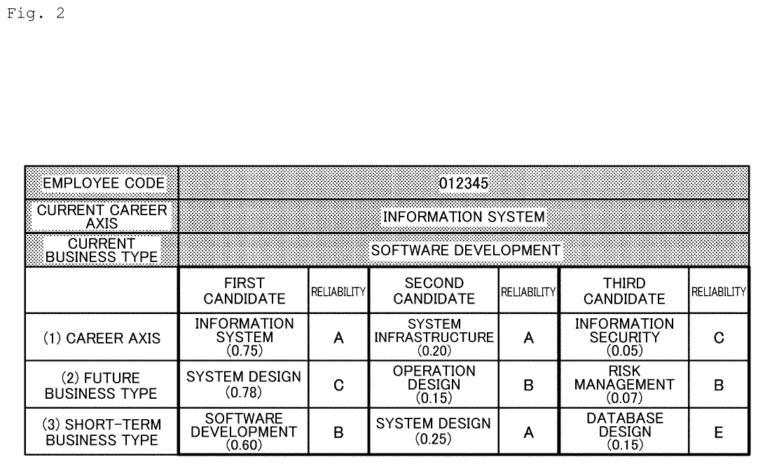

For example, as shown in FIG. 2, career plan candidates include three terms appropriate for a target employee: (1) career axis (directivity of the employee's career), (2) future business type (type of the employee's business at the completion stage of his/her career), and (3) short-term business type (type of business performed by the employee in a short term in the future, such as job rotation).

For example, as shown in FIG. 2, career plan candidates for an employee may indicate first to third candidates of business type appropriate for the employee with respect to each of the above items (1) to (3). In addition, an estimated value for reliability may be included for each business type.

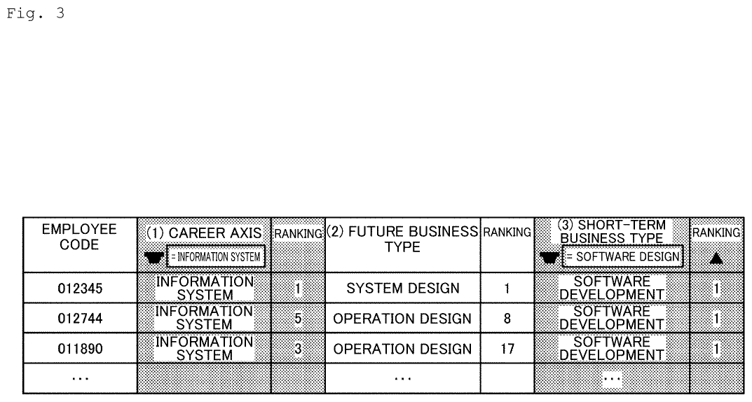

Meanwhile, the career plan candidates may be arranged for the employee's manager. For example, career plan candidates for a manager may collectively show career plan candidates with respect to the above terms (1) to (3) for a plurality of employees (see FIG. 3). Meanwhile, the career plan for each employee may be sorted or filtered using, for example, business types shown in (1) to (3) as keys so that the manager can quickly find employees who have an aptitude.

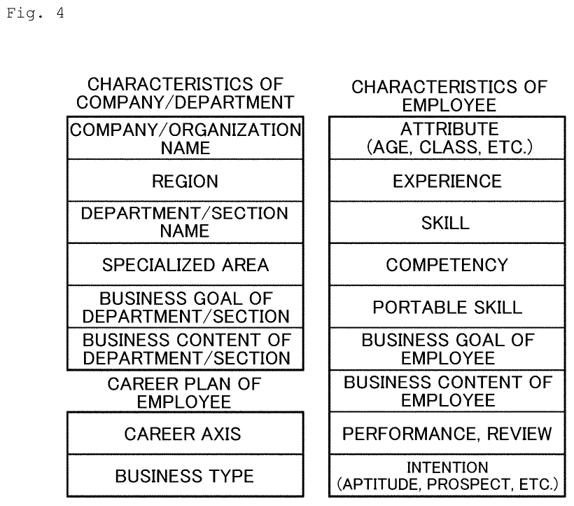

Next, reference will be made to FIG. 4 to describe personnel DB data used by the estimation device 10 and an overview of model learning performed by the estimation device 10. The personnel DB data includes, for example, information such as the characteristics of a company/department, the characteristics of an employee, and career plans of the employee as shown in FIG. 4.

The employee's career plan includes the “career axis,” “business type,” and the like described above. The “career axis” is information indicating the directivity of an employee's career, and is set with a general keyword indicating business types such as, for example, information systems, system infrastructure, information security, sales, and general affairs. Meanwhile, “intention (aptitude, prospect)” in the “characteristics of an employee” reflects the results of an intention survey such as the presence or absence of aptitude for the employee's current business type and his/her prospects.

The estimation device 10 performs model learning using data of employees who have responded that they “have an aptitude” for the current business type in the above personnel DB data.

For example, the estimation device 10 generates feature amounts (business feature) from each piece of data of the “characteristics of a company/department” and “characteristics of an employee” in the data of employees who have responded that they “have an aptitude” for the current business type in the personnel DB data. The estimation device 10 performs model learning using pairs of generated feature amounts and targets ((1) career axis, (2) future business type, and (3) short-term business type described above) as learning data.

For example, the estimation device 10 learns three models appropriate for employees: (1) a model for estimating candidates for the career axis, (2) a model for estimating candidates for the future business type, and (3) a model for estimating candidates for the short-term business type.

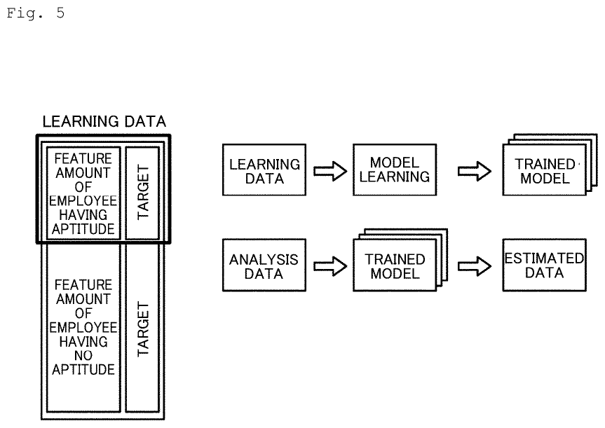

For example, as shown in FIG. 5, the estimation device 10 extracts, as learning data, the data of employees who have responded that they “have an aptitude” (pairs of feature amounts of employees who have an aptitude and targets) from the above personnel DB data. The estimation device 10 then learns the three models using the learning data.

Thereafter, when analysis data (for example, data obtained by extracting feature amounts from this year's personnel data) is created, the estimation device 10 applies the three models to this analysis data to obtain estimation data for each of (1) career axis, (2) future business type, and (3) short-term business type which are appropriate for target employees. This allows the estimation device 10 to estimates career plan candidates appropriate for employees.

### CONFIGURATION EXAMPLE

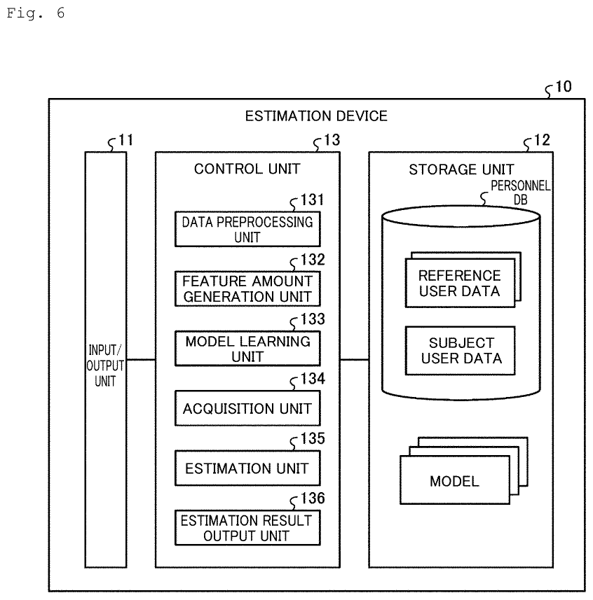

Next, the configuration example of the estimation device 10 will be described with reference to FIG. 6. The estimation device 10 includes, for example, an input/output unit 11, a storage unit 12, and a control unit 13 as shown in FIG. 6.

The input/output unit 11 is an interface for inputting and outputting various types of information to and from the estimation device 10. For example, the input/output unit 11 accepts an input of personnel data or outputs the results of estimating career plan candidates for each employee.

The storage unit 12 stores data for the control unit 13 to execute various types of processes. The storage unit 12 stores, for example, personnel data. The personnel data includes, for example, reference user data (for example, personnel data up to the previous year) and subject user data (for example, this year's personnel data). In addition, the storage unit 12 stores models trained by the control unit 13 (for example, models related to (1) to (3) described above).

The control unit 13 controls the entire estimation device 10. The control unit 13 includes a data preprocessing unit 131, a feature amount generation unit 132, a model learning unit 133, an acquisition unit 134, an estimation unit 135, and an estimation result output unit 136.

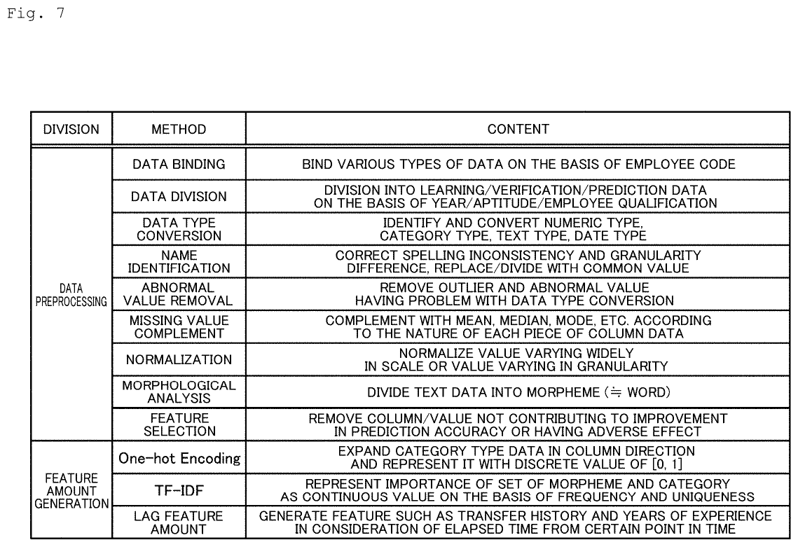

The data preprocessing unit 131 performs preprocessing on personnel data. The preprocessing here includes, for example, data binding, data division, data type conversion, name identification, abnormal value removal, missing value complement, normalization, morphological analysis, feature selection, and the like with respect to the personnel data (see FIG. 7).

The feature amount generation unit 132 generates feature amounts from the preprocessed personnel data. For example, the feature amount generation unit 132 generates feature amounts (business features) from each piece of data of the “characteristics of a company/department” and “characteristics of an employee” included in the preprocessed personnel data. For example, the feature amount generation unit 132 generates feature amounts from each piece of data of the “characteristics of a company/department” and “characteristics of an employee” included in the preprocessed personnel data through One-hot Encoding, TF-IDF, lag feature amounts, and the like shown in FIG. 7.

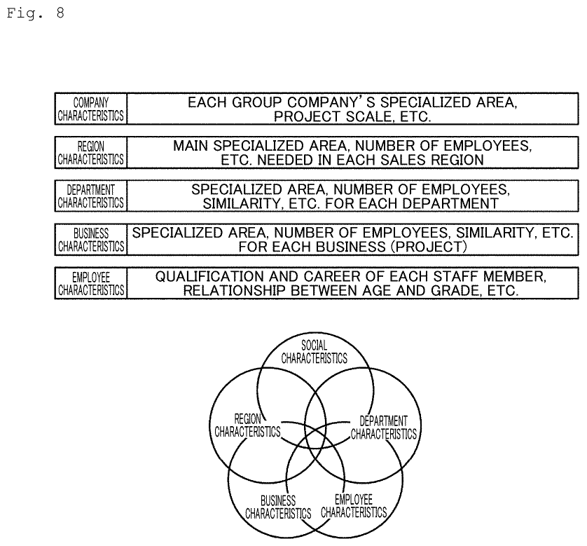

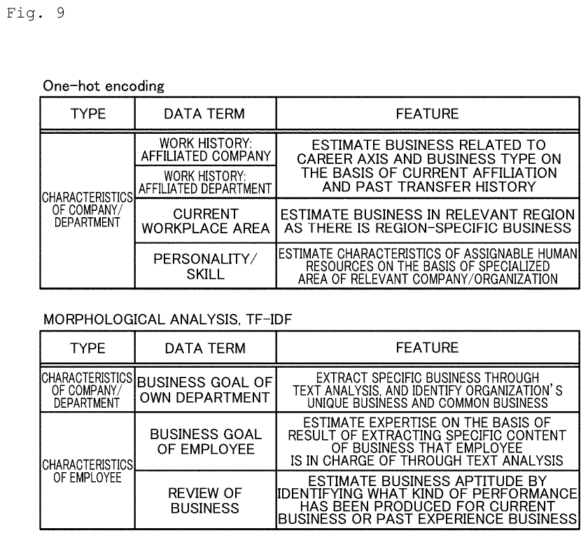

Meanwhile, when feature amounts are generated, the feature amount generation unit 132 generates, for example, feature amounts related to five characteristics shown in FIG. 8 (company characteristics, region characteristics, department characteristics, business characteristics, and employee characteristics). For example, the feature amount generation unit 132 generates feature amounts of each data term shown in FIG. 9 through One-hot Encoding, morphological analysis, and TF-IDF with respect to the above five characteristics.

For example, the feature amount generation unit 132 generates feature amounts related to work history: affiliated company and work history: affiliated department through One-hot Encoding with respect to the “characteristics of a company/department.” By using such feature amounts, the estimation unit 135 can estimate business related to the career axis and business type on the basis of the employee's current affiliation and past transfer history.

In addition, for example, the feature amount generation unit 132 generates feature amounts related to the current workplace area through One-hot Encoding with respect to the “characteristics of a company/department.” Since the business has region-specific business, the estimation unit 135 can use such feature amounts to estimate business in the relevant region as business appropriate for the employee.

In addition, for example, the feature amount generation unit 132 generates feature amounts related to the employee's personality/skill through One-hot Encoding with respect to the “characteristics of a company/department.” By using such feature amounts, the estimation unit 135 can estimate the characteristics of human resources that can be assigned on the basis of the specialized area of the relevant company/organization.

In addition, for example, the feature amount generation unit 132 generates feature amounts related to the business goals of its own department through morphological analysis and TF-IDF with respect to the “characteristics of a company/department.” That is, the feature amount generation unit 132 generates feature amounts by extracting specific business content through text analysis of the business goals of its own department. By using such feature amounts, the estimation unit 135 can identify the unique business and common business of the organization.

In addition, the feature amount generation unit 132 generates feature amounts related to the employee's business goals and business review through morphological analysis and TF-IDF with respect to the “characteristics of an employee.” That is, the feature amount generation unit 132 extracts the specific content of business that the employee is in charge of through text analysis of the employee's business goals. The feature amount generation unit 132 then uses the extraction result to generate feature amounts. By using such feature amounts, the estimation unit 135 can estimate the employee's expertise.

Further, the feature amount generation unit 132 generates feature amounts related to the review of business through morphological analysis and TF-IDF with respect to the “characteristics of a company/department.” That is, the feature amount generation unit 132 extracts the current business or business experienced in the past through text analysis of the review of business. The feature amount generation unit 132 then uses the extraction results to generate feature amounts. By using such feature amounts, the estimation unit 135 can identify what kind of performance the employee has produced in relation to his/her current business or past experience business, and estimate the employee's business aptitude.

FIG. 6 will be described again. The model learning unit 133 uses the learning data to learn models of (1) career axis, (2) future business type, and (3) short-term business type. For example, the model learning unit 133 learns models related to the above (1) to (3) using, as learning data, the pairs of feature amounts generated from each piece of data of the “characteristics of a company/department” and “characteristics of an employee” for users who have responded that they have an aptitude for their current business field, in the personnel data, and targets ((1) career axis, (2) future business type, and (3) short-term business type).

That is, the model learning unit 133 learns three models appropriate for an employee from the employee's business feature: (1) a model for estimating candidates for the career axis, (2) a model for estimating candidates for the future business type, and (3) a model for estimating candidates for the short-term business type.

Here, a description will be given of a feature amount with a high degree of importance by applying a random forest classifier to reference user data.

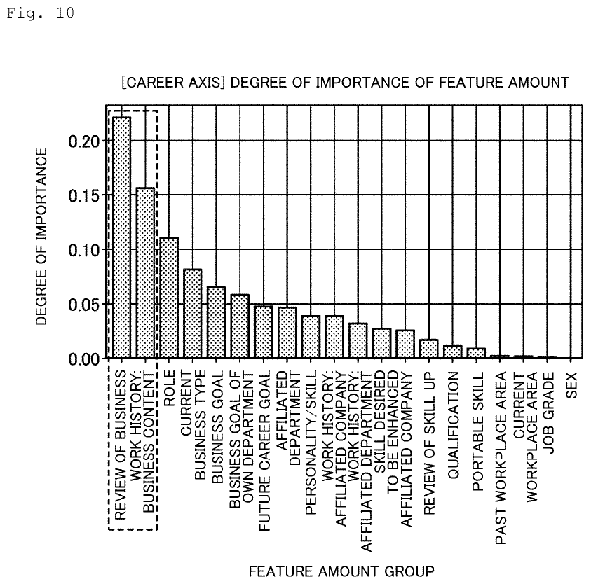

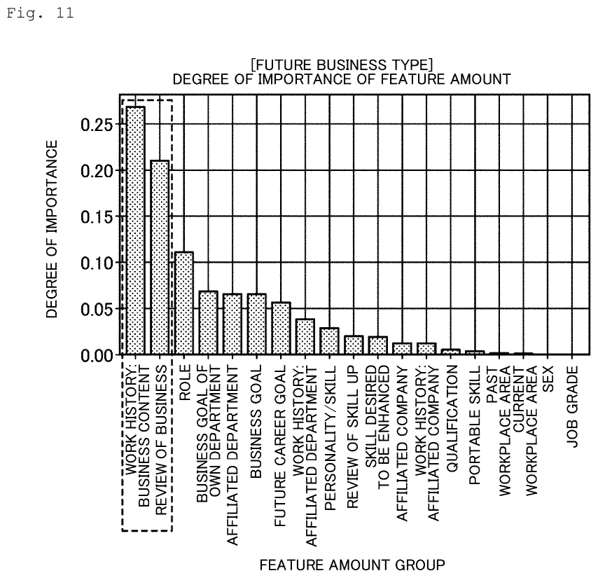

For example, as shown in FIG. 10, with regard to (1) career axis, the degrees of importance of the review of business (what kind of performance the employee has produced for the current business or past experience business), work history: business content, and the like were high. In addition, as shown in FIG. 11, with regard to (2) future business type, the degrees of importance of work history: business content, the review of business, and the like were high. This can be assumed to be because the current business and the business experienced in the past have a strong influence on the career axis and the future business type.

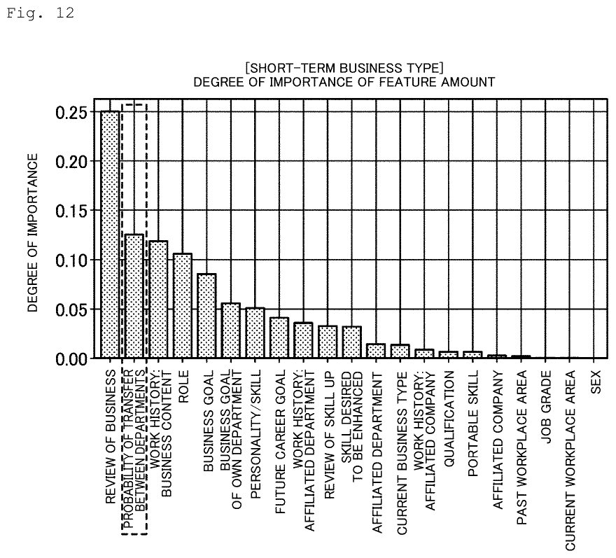

Further, as shown in FIG. 12, with regard to (3) short-term business type, the degrees of importance of the probability of transfer between departments and the like were high following the review of business. It can be assumed that the degree of importance of the probability of transfer between departments was high because of the influence of the ease of transfer between departments for the above short-term business type.

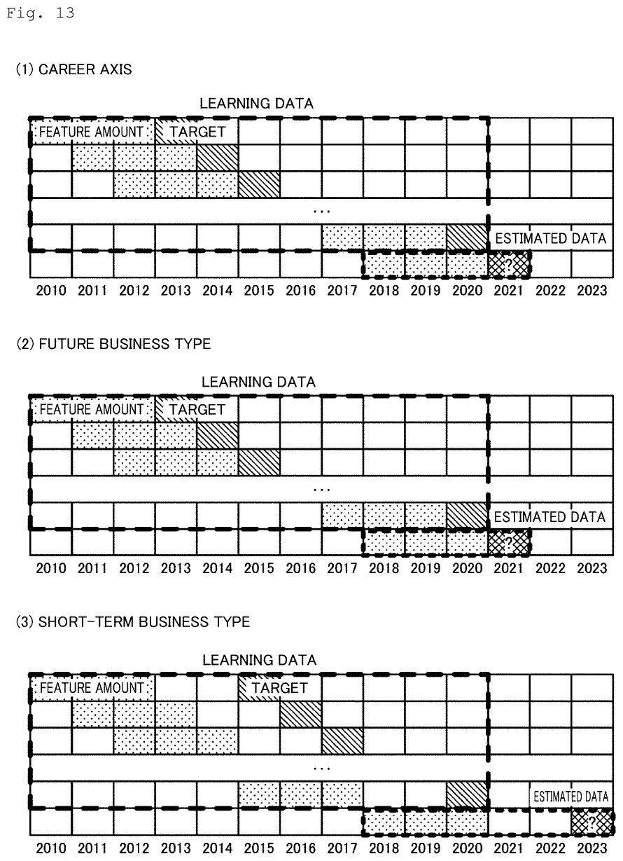

Meanwhile, the model learning unit 133 sets targets as shown in FIG. 13, for example, in model learning of the above (1) to (3).

For example, in the case of model learning for (1) career axis, the model learning unit 133 learns a model by targeting three years' worth of feature amounts of an expert-level employee who has responded that he/she has an aptitude and the type of business of the employee one year later in the reference user data.

In addition, in the case of model learning for (2) future business type, the model learning unit 133 learns a model by targeting three years' worth of feature amounts of an expert-level employee who has responded that he/she has an aptitude and the type of business of the employee one year later in the reference user data.

In addition, in the case of model learning for (3) short-term business type, the model learning unit 133 learns a model by targeting three years' worth of feature amounts of an employee who has responded that he/she has an aptitude and the type of business of the employee three years later in the reference user data.

FIG. 6 will be described again. The acquisition unit 134 acquires the features of business that the subject user for whom career plan candidates are to be estimated has been in charge of up to the present. For example, the acquisition unit 134 acquires feature amounts (business features) for each business that the subject user has been in charge of up to the present from the subject user data within the personnel DB.

The estimation unit 135 estimates career plan candidates appropriate for the subject user from the subject user's business features on the basis of the models related to the above (1) to (3) trained by the model learning unit 133. For example, the estimation unit 135 estimates career plan candidates appropriate for the subject user for the career axis from the subject user's business features (such as, for example, a review of the user's business and the user's business content) on the basis of the model related to (1) career axis.

In addition, for example, the estimation unit 135 estimates career plan candidates appropriate for the subject user for the future business type from the subject user's business features (such as, for example, a review of the user's business and the user's business content) on the basis of the model related to (2) future business type.

Further, for example, the estimation unit 135 estimates career plan candidates appropriate for the subject user for the short-term business type from the subject user's business features (such as, for example, a review of the user's business and the probability of transfer between departments) on the basis of the model related to (3) short-term business type.

The estimation result output unit 136 outputs the career plan candidates appropriate for the subject user estimated by the estimation unit 135 through the input/output unit 11. For example, as shown in FIG. 2, the estimation result output unit 136 outputs the career plan candidates appropriate for the subject user with respect to each of (1) career axis, (2) future business type, and (3) short-term business type described above.

### EXAMPLE OF PROCESSING PROCEDURE

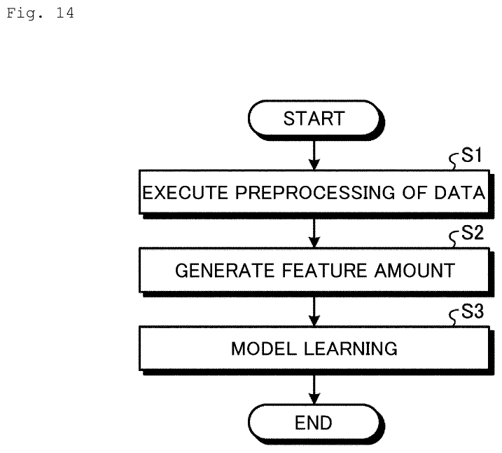

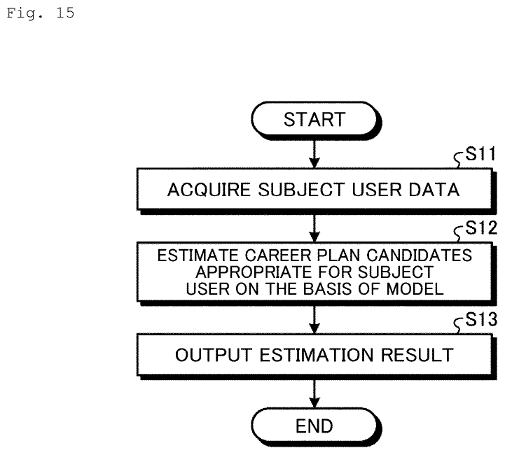

Next, an example of a processing procedure of the estimation device 10 will be described with reference to FIGS. 14 and 15. First, an example of a processing procedure of model learning will be described with reference to FIG. 14.

First, the data preprocessing unit 131 of the estimation device 10 executes preprocessing of personnel data (reference user data and subject user data) in the personnel DB (S1). The feature amount generation unit 132 then generates feature amounts from the data after preprocessing is executed (S2). Thereafter, the model learning unit 133 uses the feature amounts generated in S2 to perform model learning related to the above (1) to (3) (S3).

Next, an example of a processing procedure of estimating career plan candidates for a subject user will be described with reference to FIG. 15. First, the acquisition unit 134 of the estimation device 10 acquires data of the subject user (S11). For example, the acquisition unit 134 acquires business features (feature amounts) for each business from the preprocessed data of the subject user.

After S11, the estimation unit 135 estimates career plan candidates appropriate for the subject user on the basis of the subject user data acquired in S11 and the models related to (1) to (3) trained in S3 of FIG. 14 (S12). For example, the estimation unit 135 estimates career plan candidates appropriate for the subject user with respect to each of (1) career axis, (2) future business type, and (3) short-term business type. Thereafter, the estimation result output unit 136 outputs the estimation results in S12 (S13).

### VERIFICATION OF ESTIMATION ACCURACY

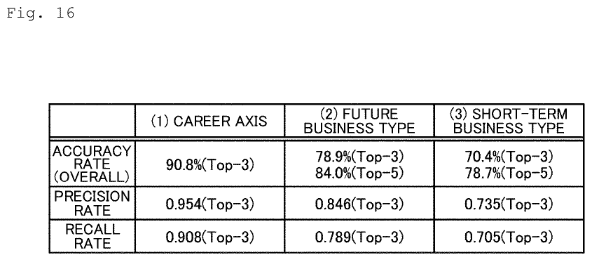

FIG. 16 shows the results of verifying the accuracy of estimation of career plan candidates for the subject user performed by the estimation device 10. Here, the estimation device 10 has used a random forest classifier to construct models for each of (1) career axis, (2) future business type, and (3) short-term business type described above. The estimation device 10 then has used each of the constructed models of (1) to (3) to estimate career plan candidates for each employee in 2020 on the basis of personnel data up to 2019.

The accuracy rate, precision rate, and recall rate of the results of estimation performed by the estimation device 10 for each of (1) career axis, (2) future business type, and (3) short-term business type described above were values shown in FIG. 16. From this, it has been confirmed that the estimation device 10 can accurately estimate career plan candidates appropriate for the subject user.

### SYSTEM CONFIGURATION AND THE LIKE

In addition, components of each unit illustrated in the drawings are functionally conceptual and are not necessarily physically configured as illustrated in the drawings. That is, the specific aspects of distribution and integration of the devices are not limited to those illustrated in the drawings. All or some of them may be distributed or integrated functionally or physically in desired units depending on various kinds of loads and states of use, or the like. Further, all or desired some of the processing functions performed by the devices can be realized by a CPU and a program executed by the CPU, or be realized as hardware based on a wired logic.

In addition, all or some of the processes described as automatically performed processes out of the processes described in the above embodiment may be performed manually. Alternatively, all or some of the processes described as manually performed processes may be performed automatically by a known method. Furthermore, the processing procedures, the control procedures, the specific names, and the information including various types of data and parameters described in the present specification and the drawings can be optionally changed unless otherwise mentioned.

### PROGRAM

The estimation device 10 can be implemented by installing a program (estimation program) as package software or online software on a desired computer. For example, an information processing device can be allowed to function as the estimation device 10 by causing the information processing device to execute the above program. The category of the information processing device referred to here includes a mobile communication terminal such as a smartphone, a cellular phone, or a personal handyphone system (PHS), a terminal such as a personal digital assistant (PDA), and the like.

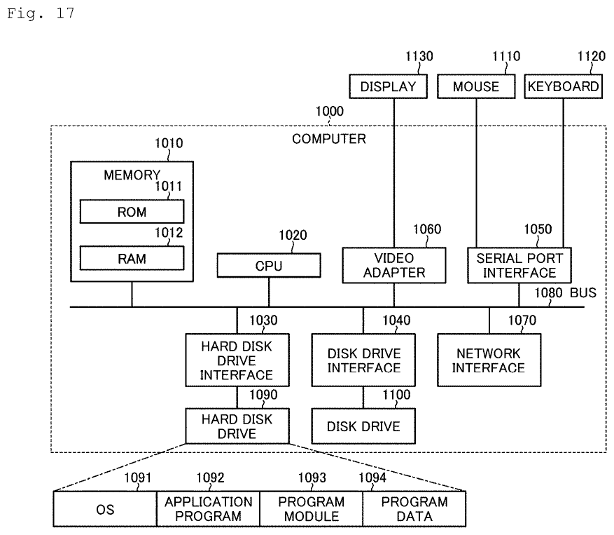

FIG. 17 is a diagram illustrating an example of a computer that executes an estimation program. A computer 1000 includes, for example, a memory 1010 and a CPU 1020. In addition, the computer 1000 includes a hard disk drive interface 1030, a disk drive interface 1040, a serial port interface 1050, a video adapter 1060, and a network interface 1070. These units are connected to each other through a bus 1080.

The memory 1010 includes a read only memory (ROM) 1011 and a random access memory (RAM) 1012. The ROM 1011 stores a boot program such as, for example, a basic input output system (BIOS). The hard disk drive interface 1030 is connected to a hard disk drive 1090. The disk drive interface 1040 is connected to a disk drive 1100. A removable storage medium such as, for example, a magnetic disc or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program for specifying each process executed by the estimation device 10 is implemented as the program module 1093 in which a computer-executable code is written. The program module 1093 is stored on, for example, the hard disk drive 1090. For example, the program module 1093 for executing processing similar to the functional configuration in the estimation device 10 is stored in the hard disk drive 1090. Meanwhile, the hard disk drive 1090 may be replaced with a solid state drive (SSD).

In addition, the data used for the processing of the above-described embodiment is stored in, for example, the memory 1010 or the hard disk drive 1090 as the program data 1094. The CPU 1020 reads out and executes the program module 1093 or the program data 1094 stored in the memory 1010 or the hard disk drive 1090, as necessary, into the RAM 1012.

Meanwhile, the program module 1093 and the program data 1094 are not necessarily stored in the hard disk drive 1090, and may be stored in, for example, a removable storage medium and be read out by the CPU 1020 through the disk drive 1100 or the like. Alternatively, the program module 1093 and the program data 1094 may be stored in another computer connected through a network (such as a local area network (LAN) or a wide area network (WAN)). The program module 1093 and the program data 1094 may be read out by the CPU 1020 from another computer through the network interface 1070.

### REFERENCE SIGNS LIST

10 Estimation device
11 Input and output unit
12 Storage unit
13 Control unit
131 Data preprocessing unit
132 Feature amount generation unit
133 Model learning unit
134 Acquisition unit
135 Estimation unit
136 Estimation result output unit

1. An estimation device for estimating career plan candidates for a subject user, the device comprising:
acquisition circuitry configured to acquire business features for each business that the subject user has been in charge of up to the present;
estimation circuitry configured to estimate career plan candidates appropriate for the subject user from the subject user's business features on the basis of a model trained using business features of each reference user who has responded that he/she has an aptitude for his/her current business field; and
estimation result output circuitry configured to output results of estimating the estimated career plan candidates appropriate for the subject user.

2. The estimation device according to claim 1, wherein:
the career plan candidates are candidates for business fields serving as an axis of the subject user's career in the future, and
the business features include at least a review of the user's business and the user's business content.

3. The estimation device according to claim 1, wherein:
the career plan candidates are the subject user's business type in a long term, and
the business features include at least a review of the user's business and the user's business content.

4. The estimation device according to claim 1, wherein:
the career plan candidates are the subject user's business type in a short term, and
the business features include a review of the user's business and a probability of transfer between departments.

5. An estimation method, comprising:
acquiring business features for each business that a subject user for whom career plan candidates are to be estimated has been in charge of up to the present;
estimating career plan candidates appropriate for the subject user from the subject user's business features on the basis of a model trained using business features of each reference user who has responded that he/she has an aptitude for his/her current business field; and
outputting results of estimating the career plan candidates appropriate for the subject user.

6. A non-transitory computer readable medium storing an estimation program for causing a computer to execute:
acquiring business features for each business that a subject user for whom career plan candidates are to be estimated has been in charge of up to the present;
estimating career plan candidates appropriate for the subject user from the subject user's business features on the basis of a model trained using business features of each reference user who has responded that he/she has an aptitude for his/her current business field; and
outputting results of estimating the career plan candidates appropriate for the subject user.
